(19) United States
(12) Patent Application Publication
(10) Pub. No.: US 2022/0186752 A1
(43) Pub. Date: Jun. 16, 2022

(54) SPOOL TYPE FLOW CONTROL VALVE AND MANUFACTURING METHOD THEREOF

(71) Applicant: SUMITOMO HEAVY INDUSTRIES, LTD., Tokyo (JP)

(72) Inventors: Tatsuya Yoshida, Kanagawa (JP); Daisuke Shinohira, Kanagawa (JP)

(21) Appl. No.: 17/546,711

(22) Filed: Dec. 9, 2021

(30) Foreign Application Priority Data
Dec. 10, 2020 (JP) 2020-205137

(51) Int. Cl. F15B 9/09; F16K 11/07; F16K 37/00

(52) U.S. Cl. CPC F15B 9/09; F16K 37/00; F16K 11/07

(57) ABSTRACT

There is provided a spool type flow control valve including a sleeve in which a supply port, a control port, and an exhaust port are formed, and a spool accommodated to be movable in an axial direction inside the sleeve and including a valve body. The valve body controls an opening area of the control port so that a flow rate is controlled. A difference between a maximum value and a minimum value of an internal leakage amount which is a flow rate at which a gas supplied from the supply port is discharged from the exhaust port in a state where the control port is shut off is equal to or smaller than a predetermined threshold.

### RELATED APPLICATIONS

The content of Japanese Patent Application No. 2020-205137, on the basis of which priority benefits are claimed in an accompanying application data sheet, is in its entirety incorporated herein by reference.

### BACKGROUND

### Technical Field

Certain embodiments of the present invention relate to a spool type flow control valve and a manufacturing method thereof.

### Description of Related Art

A spool type flow control valve that controls a flow rate of gas supplied to a control target such as a gas pressure actuator is known. In the related art, a spool type flow control valve is disclosed as follows. A spool is supported by a sleeve in a non-contact manner via a static pressure air bearing. According to the spool type flow control valve, sliding friction is not generated between the sleeve and the spool. Accordingly, the spool can be positioned with high accuracy. Therefore, the flow rate of the gas supplied to the control target can be controlled with high accuracy.

### SUMMARY

According to an embodiment of the present invention, there is provided a spool type flow control valve including a sleeve in which a supply port, a control port, and an exhaust port are formed, and a spool accommodated to be movable in an axial direction inside the sleeve and including a valve body. The valve body controls an opening area of the control port so that a flow rate is controlled. A difference between a maximum value and a minimum value of an internal leakage amount which is a flow rate at which a gas supplied from the supply port is discharged from the exhaust port in a state where the control port is shut off is equal to or smaller than a predetermined threshold.

According to another embodiment of the present invention, there is provided a spool type flow control valve. The spool type flow control valve includes a sleeve in which a supply port, a control port, and an exhaust port are formed, and a spool accommodated to be movable in an axial direction inside the sleeve and including a valve body. The valve body controls an opening area of the control port so that a flow rate is controlled. At least one of the sleeve and the spool is formed to have a dimension based on an internal leakage amount which is a flow rate at which a gas supplied from the supply port is discharged from the exhaust port in a state where the control port is shut off.

According to still another embodiment of the present invention, there is provided a manufacturing method of a spool type flow control valve including a sleeve in which a supply port, a control port, and an exhaust port are formed, and a spool accommodated to be movable in an axial direction inside the sleeve and including a valve body, the valve body controlling an opening area of the control port so that a flow rate is controlled. The manufacturing method of a spool type flow control valve includes processing at least one of the sleeve and the spool to have a dimension based on an internal leakage amount which is a flow rate at which a gas supplied from the supply port is discharged from the exhaust port in a state where the control port is shut off.

According to still another embodiment of the present invention, there is provided a manufacturing method of a spool type flow control valve including a sleeve in which a supply port, a control port, and an exhaust port are formed, and a spool accommodated to be movable in an axial direction inside the sleeve and including a valve body, the valve body controlling an opening area of the control port so that a flow rate is controlled. The manufacturing method of a spool type flow control valve includes inspecting whether or not a difference between a maximum value and a minimum value of an internal leakage amount which is a flow rate at which a gas supplied from the supply port is discharged from the exhaust port in a state where the control port is shut off is equal to or smaller than a predetermined threshold.

### BRIEF DESCRIPTION OF THE DRAWINGS

FIG. 1 is a view schematically illustrating a spool type flow control valve according to an embodiment.

FIGS. 2A and 2B are views for describing an operation of the spool type flow control valve in FIG. 1.

FIGS. 3A to 3C are views for describing flow rate characteristics of the spool type flow control valve.

FIGS. 4A and 4B are sectional views illustrating a valve body and a control port of a spool type flow control valve according to a reference example and a periphery thereof.

FIG. 5 is a view illustrating a measurement result of an internal leakage amount with regard to the spool type flow control valve in FIG. 1.

FIG. 6 is a view illustrating a measurement result of the flow rate characteristics with regard to the spool type flow control valve in FIG. 1.

FIG. 7 is a schematic manufacturing flowchart illustrating a process of manufacturing the spool type flow control valve in FIG. 1.

### DETAILED DESCRIPTION

A spool type flow control valve supplies gas from a supply port to a control port (and a control target) by operating a spool, and discharges the gas from the control port (and the control target) to an exhaust port. In the spool type flow control valve, due to a relationship of a gap between a valve body of the spool and an opening portion of the control port, non-linearity occurs in flow rate characteristics when a flow rate of the control port is close to zero. Due to the non-linearity, controllability of a control target connected to the control port deteriorates.

It is desirable to provide a spool type flow control valve capable of improving the controllability of the control target.

Any desired combinations of the above-described components or those in which the components and expressions according to the embodiments of the present invention are substituted with each other in methods, devices, and systems are also effective as an aspect according to the present invention.

According to embodiments of the present invention, it is possible to provide a spool type flow control valve capable of improving the controllability of the control target.

The same reference numerals will be assigned to components and members which are the same as or equal to each other in each drawing, and repeated description will appropriately be omitted. In addition, dimensions of the members in each drawing are appropriately enlarged or reduced to facilitate understanding. In addition, in each drawing, some of the members that are not important for describing the embodiments are omitted in the illustration.

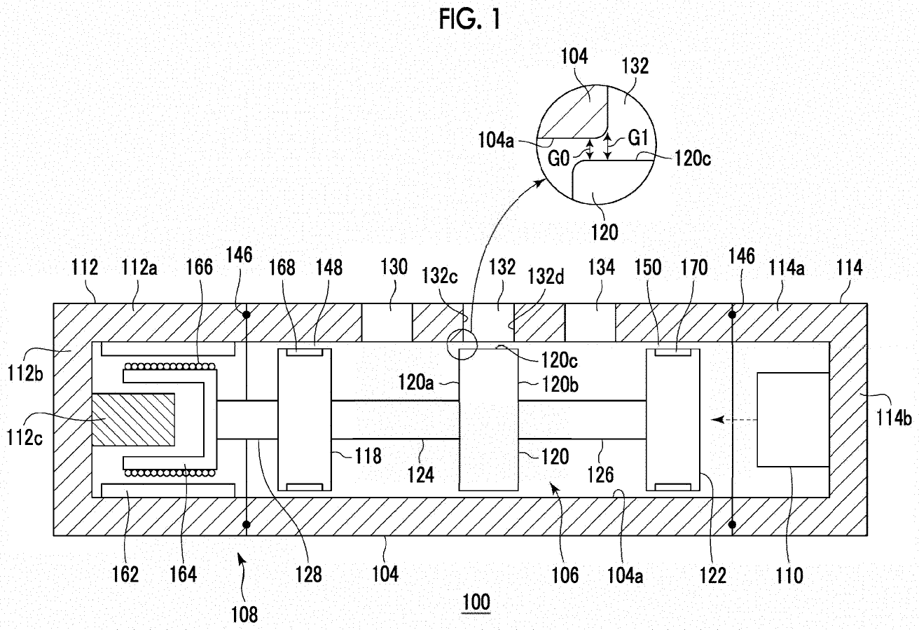

FIG. 1 is a view schematically illustrating a spool type flow control valve (servo valve) 100 according to an embodiment. The spool type flow control valve 100 is a flow control valve that controls a flow rate of gas supplied to a control target. The control target of the spool type flow control valve 100 is not particularly limited. However, for example, the control target is an air actuator. In this case, the spool type flow control valve 100 controls the flow rate of the gas supplied to the air actuator, that is, air.

The spool type flow control valve 100 includes a cylindrical sleeve 104, a spool 106 accommodated in the sleeve 104, an actuator 108 provided on one end side of the sleeve 104 and driving the spool 106 to move inside the sleeve 104, a position detection unit 110 provided on the other end side of the sleeve 104 and detecting a position of the spool 106, and a cover 114 connected to the other end side of the sleeve 104 and accommodating the position detection unit 110.

Hereinafter, a direction parallel to a center axis of the sleeve 104 will be referred to as an axial direction. In addition, a side where the actuator 108 is provided with respect to the sleeve 104 will be referred to as a left side, and a side where the position detection unit 110 is provided with respect to the sleeve 104 will be referred to as a right side.

The spool 106 includes a first support portion 118, a second support portion 122, a valve body 120, a first connection shaft 124, a second connection shaft 126, and a drive shaft 128. All of the first support portion 118, the valve body 120, and the second support portion 122 have a columnar shape, and are aligned in this order from the left side in an axial direction. The first connection shaft 124 extends in the axial direction, and connects the first support portion 118 and the valve body 120 to each other. The second connection shaft 126 extends in the axial direction, and connects the valve body 120 and the second support portion 122 to each other. The drive shaft 128 protrudes from the first support portion 118 toward the left side in the axial direction.

The actuator (linear drive unit) 108 moves the drive shaft 128 and the spool 106 in the axial direction. The actuator 108 is not particularly limited, but is a voice coil motor in the illustrated example.

The first support portion 118 and the second support portion 122 of the spool 106 are supported in a state of floating from the sleeve 104 by a static pressure gas bearing, that is, without being in contact with the sleeve 104.

In the present embodiment, an air pad 168 serving as the static pressure gas bearing is provided on an outer peripheral surface of the first support portion 118. The air pad 168 ejects compressed gas supplied from an air supply system (not illustrated) into a first gap 148 serving as a gap between the first support portion 118 and the sleeve 104. In this manner, a high-pressure gas layer is formed in the first gap 148, and the air pad 168 and the first support portion 118 float from the sleeve 104. Instead of the outer peripheral surface of the first support portion 118, the air pad 168 may be provided in a portion on an inner peripheral surface 104a of the sleeve 104 facing the first support portion 118.

Similarly, an air pad 170 serving as the static pressure gas bearing is provided on an outer peripheral surface of the second support portion 122. The air pad 170 ejects the compressed gas supplied from the air supply system (not illustrated) into the second gap 150 serving as a gap between the second support portion 122 and the sleeve 104. In this manner, the high-pressure gas layer is formed in the second gap 150, and the air pad 170 and the second support portion 122 float from the sleeve 104. Instead of the outer peripheral surface of the second support portion 122, the air pad 170 may be provided in a portion on the inner peripheral surface 104a of the sleeve 104 facing the second support portion 122.

FIG. 1 illustrates the first gap 148 and the second gap 150 which are exaggerated. In actual, a size of the first gap 148 and the second gap 150 is preferably approximately several microns in order to form the static pressure gas bearing.

The position detection unit 110 is not particularly limited. However, in this example, the spool 106 is configured to be detectable in a non-contact manner. For example, a laser sensor is used for the position detection unit 110.

The cover 114 has a bottomed cup shape in which a cylindrical portion 114a and a bottom portion 114b are integrally formed. The cover 114 is connected to a right end of the sleeve 104 so that the bottom portion 114b is located on the right, that is, the opening portion in the right end of the sleeve 104 and the opening portion face each other.

The cover 114 may be formed integrally with the sleeve 104. In other words, instead of a configuration in which the spool type flow control valve 100 does not include the cover 114, the sleeve 104 may be formed in a bottomed cylindrical shape in which only a left end is open.

The actuator 108 includes a yoke 112, a magnet 162, a coil bobbin 164, and a coil 166. The yoke 112 is made of a magnetic body such as iron. The yoke 112 has a bottomed cup shape in which a cylindrical portion 112a and a bottom portion 112b are integrally formed. The yoke 112 is connected to the left end of the sleeve 104 so that the bottom portion 112b is located on the left, that is, the opening portion in the left end of the sleeve 104 and the opening portion face each other.

The yoke 112 further has a columnar protrusion 112c that protrudes rightward from the bottom portion 112b in the axial direction. The magnet 162 is bonded and fixed to an inner peripheral surface of the cylindrical portion 112a to surround the protrusion 112c. The magnets 162 may be continuous in the circumferential direction, or may be discontinuous in the circumferential direction, that is, may intermittently be provided.

The coil bobbin 164 is provided inside the magnet 162. The coil bobbin 164 surrounds the protrusion 112c, and one end side is connected to the drive shaft 128. The coil 166 is wound around an outer periphery of the coil bobbin 164. The actuator 108 generates a force that moves the coil bobbin 164 around which the coil 166 is wound, and the spool 106 to any place in the axial direction, in response to a current supplied to the coil 166 and a current direction. A positional relationship between the magnet 162 and the coil 166 may be reversed. That is, the magnet 162 may be provided inside the coil 166, specifically, on the outer peripheral surface of the protrusion 112c.

A portion between the sleeve 104 and the yoke 112 of the actuator 108 and a portion between the sleeve 104 and the cover 114 are respectively sealed by sealing members 146 such as an 0-ring and a metal seal. Therefore, the sleeve 104, the yoke 112, and the cover 114 are internally sealed except for a plurality of ports (to be described later).

The sleeve 104 has a supply port 130, a control port 132, and an exhaust port 134. The supply port 130, the control port 132, and the exhaust port 134 are respectively communication holes that communicate with the inside and the outside of the sleeve 104, and extend in a direction perpendicular to the axial direction.

The supply port 130 is connected to a compressed gas supply source (not illustrated) via a tube or a manifold (all are not illustrated). The control port 132 is connected to a control target (not illustrated) via a tube or a manifold (all are not illustrated). When viewed in a radial direction, the control port 132 is formed in a rectangular shape having four sides parallel to the axial direction and the circumferential direction. The exhaust port 134 is open to the atmosphere via a tube or a manifold (all are not illustrated). In FIG. 1, the spool 106 is located at a neutral position, and the control port 132 is closed by the valve body 120. The neutral position refers to a position of the spool 106 where positions in the axial direction of a central portion of the valve body 120 in the axial direction and a central portion of the control port 132 in the axial direction coincide with each other.

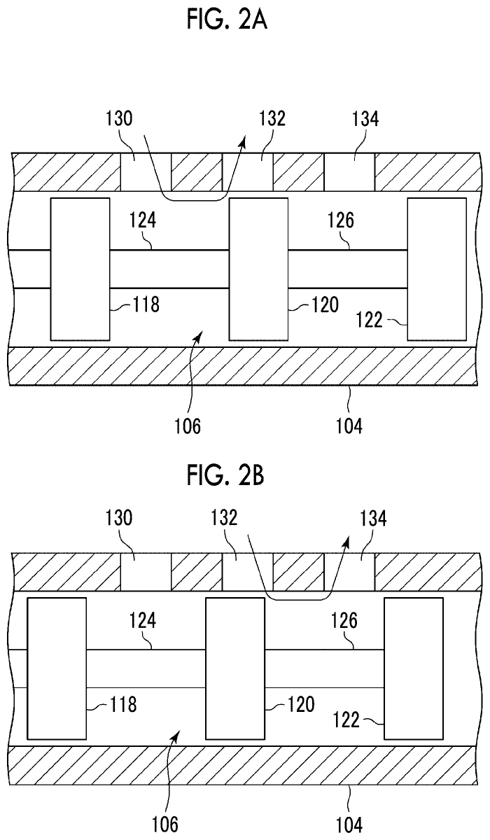

The above-described configuration is a basic configuration of the spool type flow control valve 100. Subsequently, an operation thereof will be described. FIGS. 2A and 2B are views for describing the operation of the spool type flow control valve 100 in FIG. 1.

FIG. 2A illustrates a state where the spool 106 in a state illustrated in FIG. 1 is driven by the actuator 108 and moves rightward in the axial direction. In this state, the control port 132 closed by the valve body 120 is opened. The supply port 130 and the control port 132 communicate with each other. The compressed gas from the compressed gas supply source is supplied to the control target through the supply port 130, the inside of the sleeve 104, and the control port 132. In this case, a position of the spool 106 is controlled, based on a detection result obtained by the position detection unit 110, and the opening area of the control port 132 is controlled by the valve body 120, thereby controlling a flow rate of the compressed gas supplied to the control target.

FIG. 2B illustrates a state where the spool 106 in a state illustrated in FIG. 1 is driven by the actuator 108 and moves leftward in the axial direction. In this state, the control port 132 closed by the valve body 120 is opened. The control port 132 and the exhaust port 134 communicate with each other. The compressed gas from the control target is exhausted to the atmosphere through the control port 132, the inside of the sleeve 104, and the exhaust port 134. In this case, the position of the spool 106 is controlled, based on a detection result obtained by the position detection unit 110, and the opening area of the control port 132 is controlled by the valve body 120, thereby controlling the flow rate of the compressed gas exhausted from the control target.

Subsequently, a configuration in which the controllability of the flow rate is improved by the spool type flow control valve 100 will be described in more detail.

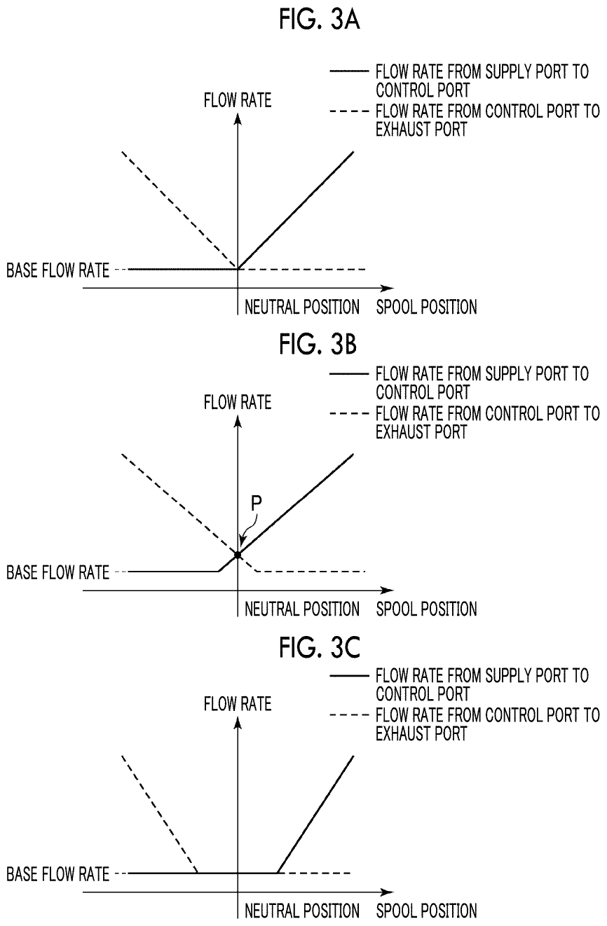

FIGS. 3A to 3C are views for describing flow rate characteristics of the spool type flow control valve. FIG. 3A illustrates ideal flow rate characteristics. FIG. 3B illustrates flow rate characteristics having non-linearity. The non-linearity of the flow rate characteristics leads to a decrease in the controllability of the flow rate. FIG. 3C illustrates flow rate characteristics having a dead zone in the vicinity of a neutral position. When a lap amount increases, the flow rate characteristics appear. The lap amount is the length at which the valve body 120 protrudes in the axial direction from the control port 132 when the sleeve 104 is located at the neutral position, in other words, the length at which the valve body 120 and the sleeve 104 are superimposed with (overlap) each other outside the control port 132 in the axial direction. When there is a dead zone, the control target cannot realize high responsiveness. Accordingly, this configuration is not preferable.

In FIGS. 3A to 3C, a constant amount of the gas always flows from the supply port to the control port and from the control port to the exhaust port, regardless of the position of the spool. The reason is as follows. The valve body is in non-contact with the sleeve. Therefore, the supply port 130 and the control port 132, and the control port 132 and the exhaust port 134 always respectively communicate with each other through a minute gap. Hereinafter, the flow rate having the constant amount will be referred to as a base flow rate.

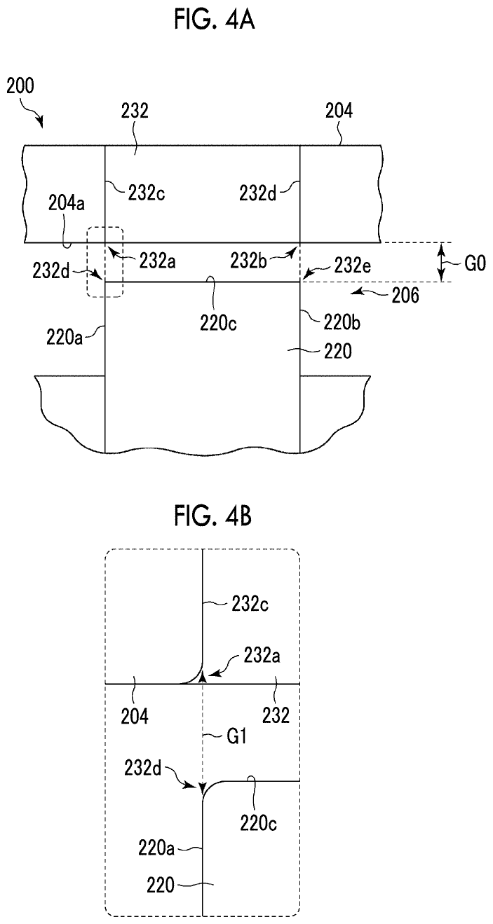

FIGS. 4A and 4B are sectional views illustrating a valve body 220 and a control port 232 of a spool type flow control valve 200 according to a reference example and a periphery thereof. FIG. 4B is an enlarged view of a portion surrounded by a broken line in FIG. 4A.

Theoretically, in order to realize the ideal flow rate characteristics illustrated in FIG. 3A, at least the followings are required.
(i) Corner portions 220d and 220e where right and left axial end surfaces 220a and 220b of the valve body 220 and the outer peripheral surface 220c are connected to each other are formed at a so-called pin angle. That is, the corner portion 220d is formed at a right angle in a cross section passing through the center axis of the valve body 220.
(ii) Opening portion peripheral edges 232a and 232b on the inner peripheral surface side of the control port 232 are formed at a so-called pin angle. That is, the opening portion peripheral edge 232a is formed at a right angle in a cross section passing through the center axis of the sleeve 204.
(iii) The valve body 220 and the control port 232 are formed so that the right and left axial end surfaces 220a and 220b of the valve body 220 and right and left peripheral surfaces 232c and 232d of the control port 232 are flush with each other when the spool 206 is located at the neutral position as illustrated in FIG. 4A.

However, in reality, due to limitation of a processing technique, not only the corner portion 220d of the valve body 220 but also the opening portion peripheral edge 232a of the control port 132 cannot be formed exactly at the pin angle, and microscopically, both are formed at a round angle. Therefore, for example, in a case where the valve body 220 and the control port 232 are configured so that the right and left axial end surfaces 220a and 220b of the valve body 220 and the right and left peripheral surfaces 232c and 232d of the control port 232 are flush with each other when the spool 206 is located at the neutral position, a gap G1 between the outer peripheral surface 220c of the valve body 220 and the opening portion peripheral edges 232a and 232b of the control port 132 when the spool 206 is located at the neutral position is wider than a gap G0 between the outer peripheral surface 220c of the valve body 220 and the inner peripheral surface 204a of the sleeve 204. As a result, the flow rate characteristics of the spool type flow control valve according to the reference example become the flow rate characteristics having non-linearity as illustrated in FIG. 3B. In order to bring the flow rate characteristics close to the ideal flow rate characteristics illustrated in FIG. 3A, at least in order to bring the gap G1 closer to the gap G0, the valve body 220 and the sleeve 204 need to overlap each other to such an extent that the dead zone is not generated.

In this way, it is not easy to realize the ideal flow rate characteristics illustrated in FIG. 3A, and it is actually impossible. In reality, the processing technique aims to the flow rate characteristics close to the ideal, that is, the flow rate characteristics having a small non-linear range.

It is conceivable to adopt the following configuration. The flow rate characteristics of the spool type flow control valve are directly measured. In this manner, whether the flow rate characteristics are close to the ideal is inspected, the lap amount is adjusted so that the flow rate characteristics are closer to the ideal flow rate characteristics, or the gap G0 between the outer peripheral surface 120c of the valve body 120 and the inner peripheral surface 104a of the sleeve 104 is adjusted. However, it is complicated to directly measure the flow rate characteristics. Consequently, it is not realistic to directly measure the flow rate characteristics to perform the inspection and the adjustment, based on measurement results thereof.

In contrast, as a result of diligent studies, the present inventors have recognized that there is a correlation between an internal leakage amount of the spool type flow control valve 100 and flow rate characteristics. Here, the “internal leakage amount” is a flow rate at which the gas supplied from the supply port 130 is discharged from the exhaust port 134 in a state where the control port 132 is shut off.

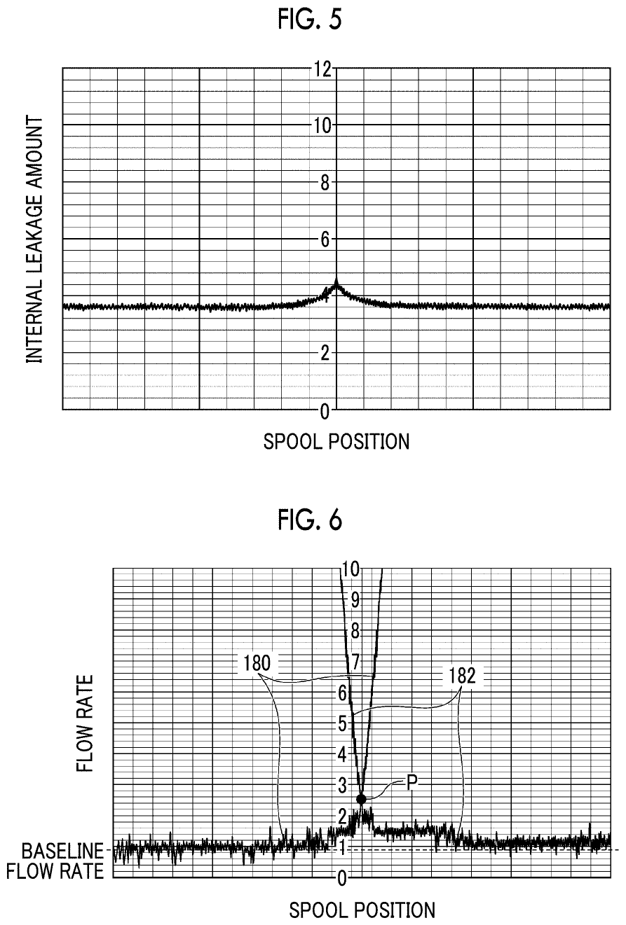

FIG. 5 is a view illustrating a measurement result of the internal leakage amount of the spool type flow control valve 100. In FIG. 5, a horizontal axis represents a position of the spool 106, and a vertical axis represents the internal leakage amount.

As illustrated in FIG. 5, the internal leakage amount increases when the spool is located in the vicinity of the neutral position. In this example, a difference between a maximum value (5.1 L/min) and a minimum value (3.5 L/min) of the internal leakage amount is 1.6 L/min.

FIG. 6 is a view illustrating a measurement results of the flow rate characteristics with regard to the spool type flow control valve 100. In FIG. 6, the horizontal axis represents the position of the spool 106, and the vertical axis represents the flow rate.

As illustrated in FIG. 6, the flow rate characteristics have non-linearity in the vicinity of the neutral position. In this example, a difference between the flow rate (2.5 L/min) at an intersection point P of a flow rate characteristic graph 180 of the compressed gas supplied from the supply port 130 to the control port 132 and a flow rate characteristic graph 182 of the compressed gas discharged from the control port 132 to the exhaust port 134 and a base flow rate (0.9 L/min) is 1.6 L/min. This difference is equal to the difference (1.6 L/min) between the maximum value and the minimum value of the internal leakage amount in FIG. 5.

In this way, the difference between the maximum value and the minimum value of the internal leakage amount is substantially equal to the difference between the flow rate at the intersection point P and the base flow rate. As the difference between the maximum value and the minimum value of the internal leakage amount is smaller, the flow rate at the intersection point P is lower, and the flow rate characteristics are closer to the ideal flow rate characteristics illustrated in FIG. 3A.

Therefore, in the present embodiment, the valve body 120 or the sleeve 104 (particularly, the control port 132) is processed, and the lap amount or the gap G0 is adjusted so that the difference between the maximum value and the minimum value of the internal leakage amount (hereinafter, referred to as an internal leakage amount difference) is a value close to zero, specifically, so that the internal leakage amount difference is equal to or smaller than a predetermined threshold Th.

Therefore, in the spool type flow control valve 100 of the present embodiment, the internal leakage amount difference is equal to or smaller than the threshold Th. The threshold Th is determined depending on desired controllability. Even in a case where the lap amount when the spool 106 is located at the neutral position is the same, when the length (width) of the control port 132 in the circumferential direction is different, the internal leakage amount difference may be different. Therefore, the threshold Th is determined based on the length of the control port 132 in the circumferential direction.

Subsequently, a manufacturing method of the spool type flow control valve 100 configured as described above will be described.

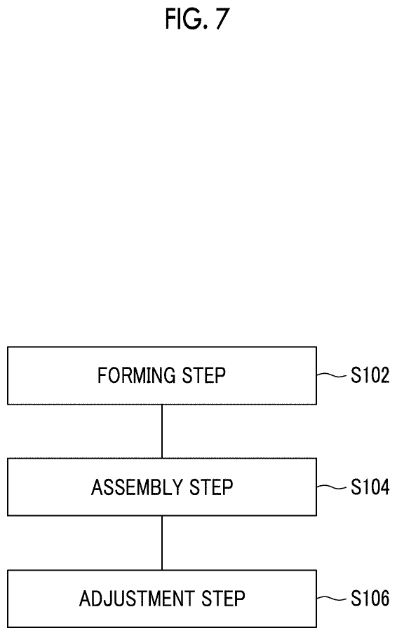

FIG. 7 is a schematic manufacturing flowchart illustrating a process of manufacturing the spool type flow control valve 100. A process of manufacturing the spool type flow control valve 100 includes a forming step S102, an assembly step S104, and an adjustment step S106.

In the forming step S102, components of the spool type flow control valve 100 such as the sleeve 104 and the spool 106 are formed. The forming step S102 may be configured by using a known processing technique such as cutting or casting.

For example, in a prototype of the spool type flow control valve 100, the lap amount at which the internal leakage amount difference is the threshold Th, and an axial dimension and a diameter of the valve body 120 and an axial dimension of the control port 132 maybe specified. In the forming step S102, the valve body 120 and the control port 132 may be processed to have the specified dimensions in this way. Alternatively, on a premise of adjustment in the adjustment step S106, the valve body 120 may be formed to have a slightly longer axial dimension, or the control port 132 may be formed to have a slightly shorter axial dimension.

In the assembly step S104, the spool type flow control valve 100 is assembled by using the components formed in the forming step S102. The assembly step S104 may be configured by using a known assembly technique.

In the adjustment step S106, the spool type flow control valve 100 is adjusted so that the internal leakage amount difference is equal to or smaller than the threshold Th. First, the supply port 130 of the sleeve 104 of the spool type flow control valve 100 is connected to a compressed gas supply source, the exhaust port 134 is opened to the atmosphere, the control port 132 is closed with a predetermined lid, and the compressed gas is supplied to the supply port 130 from the compressed gas source. In this state, the internal leakage amount when the spool 106 is located at each position in the axial direction is measured, and whether or not the internal leakage amount difference is equal to or smaller than the threshold Th is inspected. When the internal leakage amount difference is greater than the threshold Th, the lap amount and the gap G1 are adjusted. Specifically, at least one of the right and left axial end surfaces 120a and 120b of the valve body 120, the outer peripheral surface 120c, and the right and left peripheral surfaces 132c and 132d of the control port 132 is cut to perform adjustment (processing) so that the internal leakage amount difference is equal to or smaller than the threshold Th. After the adjustment, whether or not the internal leakage amount difference is equal to or smaller than the threshold Th is inspected again. Then, the inspection and the adjustment are repeatedly performed until the internal leakage amount difference is equal to or smaller than the threshold Th.

As described above, when the flow rate characteristics have the dead zone in the vicinity of the neutral position, it is not preferable since the control target cannot realize high responsiveness. Therefore, the lap amount is set to a minute lap amount that does not generate the dead zone. That is, the flow rate characteristics of the spool type flow control valve 100 have the flow rate characteristics as illustrated in FIG. 3B. In this case, the flow rate characteristic graph of the compressed gas supplied from the supply port 130 to the control port 132 and the flow rate characteristic graph of the compressed gas discharged from the control port 132 to the exhaust port 134 intersect with each other at a position higher than that of the baseline flow rate.

According to the present embodiment described above, the internal leakage amount difference of the spool type flow control valve 100 is equal to or smaller than the threshold Th. In this case, the flow rate characteristics of the spool type flow control valve 100 can be brought close to the ideal flow rate characteristics to such an extent that the desired controllability is achieved.

In addition, according to the present embodiment, the threshold Th is determined, based on the length of the control port 132 in the circumferential direction. In this manner, the controllability corresponding to the length of the control port 132 in the circumferential direction, that is, having the maximum controllable flow rate can be improved regardless of a difference in the maximum flow rate.

Hitherto, the present invention has been described with reference to the embodiments. The embodiments are merely examples. Those skilled in the art will understand that various modification examples can be made for combinations of the respective components or the respective processes, and that the modification examples also fall within the scope of the present invention.

Any desired combination of the above-described embodiments and modification examples is also useful as an embodiment of the present invention. Anew embodiment generated by the combination has advantageous effects of the respectively combined embodiment and modification examples.

It should be understood that the invention is not limited to the above-described embodiment, but may be modified into various forms on the basis of the spirit of the invention. Additionally, the modifications are included in the scope of the invention.

What is claimed is:

1. A spool type flow control valve comprising:
a sleeve in which a supply port, a control port, and an exhaust port are formed; and
a spool accommodated to be movable in an axial direction inside the sleeve and including a valve body,
wherein the valve body controls an opening area of the control port so that a flow rate is controlled, and
a difference between a maximum value and a minimum value of an internal leakage amount which is a flow rate at which a gas supplied from the supply port is discharged from the exhaust port in a state where the control port is shut off is equal to or smaller than a predetermined threshold.

2. The spool type flow control valve according to claim 1,
wherein the threshold is determined, based on a length of the control port in a circumferential direction.

3. A spool type flow control valve comprising:
a sleeve in which a supply port, a control port, and an exhaust port are formed; and
a spool accommodated to be movable in an axial direction inside the sleeve and including a valve body,
wherein the valve body controls an opening area of the control port so that a flow rate is controlled, and
at least one of the sleeve and the spool is formed to have a dimension based on an internal leakage amount which is a flow rate at which a gas supplied from the supply port is discharged from the exhaust port in a state where the control port is shut off.

4. A manufacturing method of a spool type flow control valve including a sleeve in which a supply port, a control port, and an exhaust port are formed, and a spool accommodated to be movable in an axial direction inside the sleeve and including a valve body, the valve body controlling an opening area of the control port so that a flow rate is controlled, the method comprising:
processing at least one of the sleeve and the spool to have a dimension based on an internal leakage amount which is a flow rate at which a gas supplied from the supply port is discharged from the exhaust port in a state where the control port is shut off.

5. The manufacturing method of a spool type flow control valve according to claim 4,
wherein in the processing, at least one of the sleeve and the spool is processed so that a difference between a maximum value and a minimum value of the internal leakage amount is equal to or smaller than a predetermined threshold.

6. The manufacturing method of a spool type flow control valve according to claim 5,
wherein the threshold is determined, based on a length of the control port in a circumferential direction.

7. A manufacturing method of a spool type flow control valve including a sleeve in which a supply port, a control port, and an exhaust port are formed, and a spool accommodated to be movable in an axial direction inside the sleeve and including a valve body, the valve body controlling an opening area of the control port so that a flow rate is controlled, the method comprising:
inspecting whether or not a difference between a maximum value and a minimum value of an internal leakage amount which is a flow rate at which a gas supplied from the supply port is discharged from the exhaust port in a state where the control port is shut off is equal to or smaller than a predetermined threshold.
